(19) United States
(12) Patent Application Publication
(10) Pub. No.: US 2011/0178984 A1
(43) Pub. Date: Jul. 21, 2011

(54) REPLICATION PROTOCOL FOR DATABASE SYSTEMS

(75) Inventors: Tomas Talius, Sammamish, WA (US); Bruno H.M. Denuit, Redmond, WA (US)

(73) Assignee: Microsoft Corporation, Redmond, WA (US)

(21) Appl. No.: 12/688,921

(22) Filed: Jan. 18, 2010

(51) Int. Cl. G06F 17/00; G06F 12/00

(52) U.S. Cl. 707/634; 707/682; 707/812; 707/620; 707/E17.005; 707/E17.044; 707/E17.045

(57) ABSTRACT

Database management architecture for recovering from failures by building additional replicas and catching up replicas after a failure. A replica includes both the schema and the associated data. Modifications are captured, as performed by a primary replica (after the modifications have been performed), and sent asynchronously to secondary replicas. Acknowledgement by a quorum of the replicas (e.g., primary, secondaries) at transaction commit time is then awaited, and desired to be obtained. The logging of changes for recovery from failures is implemented, as well as online copying (e.g., accepting modifications during the copy) of the data when replica catch-up is not possible. Modifications can be sent asynchronously to the secondary replicas and in parallel.

### BACKGROUND

Massive amounts of data are being stored on servers for central access and efficient interaction. Running database systems on commodity hardware, however, can be problematic especially where data loss can occur due to hardware, software, and/or connectivity failures. Thus, data-redundancy can be employed, such as through replication. The database system must be able to tolerate multiple failures while maintaining transaction reliability (e.g., according to the ACID (atomicity, consistency, isolation, durability) properties).

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture addresses the implementation of transactions semantics in database management systems as well as algorithms for recovering from failures by building additional replicas and catching up replicas after a failure. The modifications to the primary replica are captured and replicated as logical level operations (in contrast to the file level) in the server. A replica includes both the schema and the associated data.

Modifications are captured, as performed on a primary replica (after the modifications have been performed), and sent asynchronously to secondary replicas. Acknowledgement by a quorum of the replicas (e.g., primary, secondaries) at transaction commit time is then awaited, and desired to be obtained. The logging of changes for recovery from failures is implemented, as well as online copying (e.g., accepting modifications during the copy) of the data when replica catch-up is not possible.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented database management system having a physical media in accordance with the disclosed architecture.

FIG. 2 illustrates an alternative embodiment of a computer-implemented database management system.

FIG. 3 illustrates an alternative embodiment of a database management system having a failover system.

FIG. 4 illustrates a diagram that represents transaction commits relative to a replication queue.

FIG. 5 illustrates a diagram of catch-up and transaction overlap processing according to the disclosed database management architecture.

FIG. 6 illustrates a diagram for a copy algorithm for online copies.

FIG. 7 illustrates a computer-implemented method of database management employing a processor and memory, in accordance with the disclosed architecture.

FIG. 8 illustrates further aspects of the method of FIG. 7.

FIG. 9 illustrates a block diagram of a computing system that executes database management in accordance with the disclosed architecture.

FIG. 10 illustrates a schematic block diagram of a computing environment that utilizes data management according to disclosed embodiments.

### DETAILED DESCRIPTION

The disclosed architecture captures modifications performed by primary replica after the modifications have been performed, asynchronously sends the modifications to secondary replicas, and waits for acknowledgement of quorum of the replicas (primary and secondary) at transaction commit time. Moreover, logging of the modifications is performed for recovery from failures. Additionally, online copy (accepting modifications during the copy) of data is provided when catch-up by the secondary replicas is not possible.

Herein are provided concepts of a partition as a transactionally consistent unit of schema and data and replicas as copies of a partition. A partition is a unit of scale-out in a distributed database system. Replicas can be placed on multiple machines to protect against hardware and software failures. Each partition includes one primary replica and multiple secondary replicas. All writes are performed against the primary replica; reads can optionally be performed against secondary replicas as well.

All modifications (or changes) performed against the replica indexes are captured as the modifications are performed (e.g., by the relational engine) in the database system. Accordingly, the following benefits can be obtained: the changes have already been synchronized against other reads/modifications using transactional semantics (relevant locks have been acquired); since the changes have succeeded on the primary replica the changes are guaranteed to succeed on the secondary replica (or else, the secondary replica fails); the changes are deterministic in that the changes are the actual data values as opposed to non-deterministic expressions (e.g., the “current date”); and, full index rows can be replicated, which allows for additional I/O (input/output) optimizations on secondary replicas.

Each node (machine) maintains information on which partitions the node serves and how many changes the node has seen so far. During failover, the most advanced replica will get picked as a new primary. In addition, primaries keep track of where the secondaries are for its partitions.

Regular data access operations lock the partitions when operating on either primary or secondary replicas. If after the lock is acquired the partition does not serve the partition key for which the operation is intended, the transaction is rolled back. This can occur on the primary replica if the replica is discovered only after the first modification is performed in a transaction. On secondaries, the partition is locked before the first row change in a transaction. Partition splits and other modifications can acquire exclusive locks on the partition table. Separate lock resources are provided for partition locking and the partition metadata update by checkpointing.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

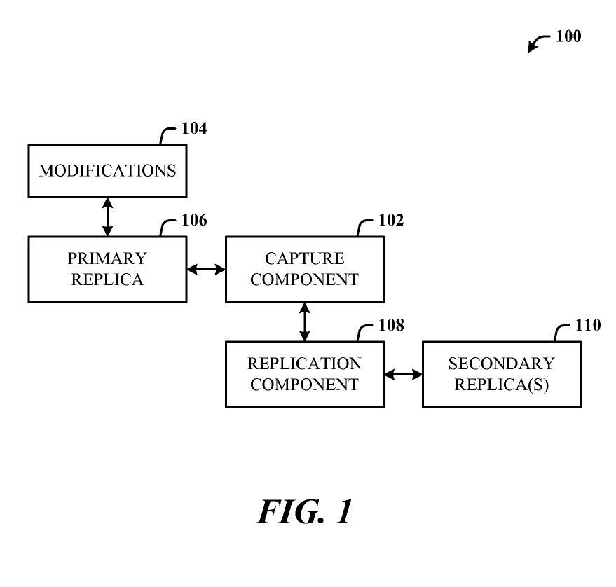

FIG. 1 illustrates a computer-implemented database management system 100 having a physical media in accordance with the disclosed architecture. The system 100 includes a capture component 102 for capturing modifications 104 performed by a primary replica 106, and a replication component 108 for sending the modifications 104 to one or more secondary replicas 110 associated with the primary replica 106. The database management system 100 can be a distributed relational database system.

The capture component 102 captures the modifications 104 by the primary replica 106 after the modifications 104 have been performed. The modifications 104 are committed based on a quorum of the primary replica 106 and secondary replicas 110. The secondary replicas 110 are constantly catching up to the state of the primary replica 106. The replication component 108 can send the modifications 104 to the secondary replicas 110 in parallel. The replication component 108 can perform online copy of schema and data from the primary replica 106 to a secondary replica.

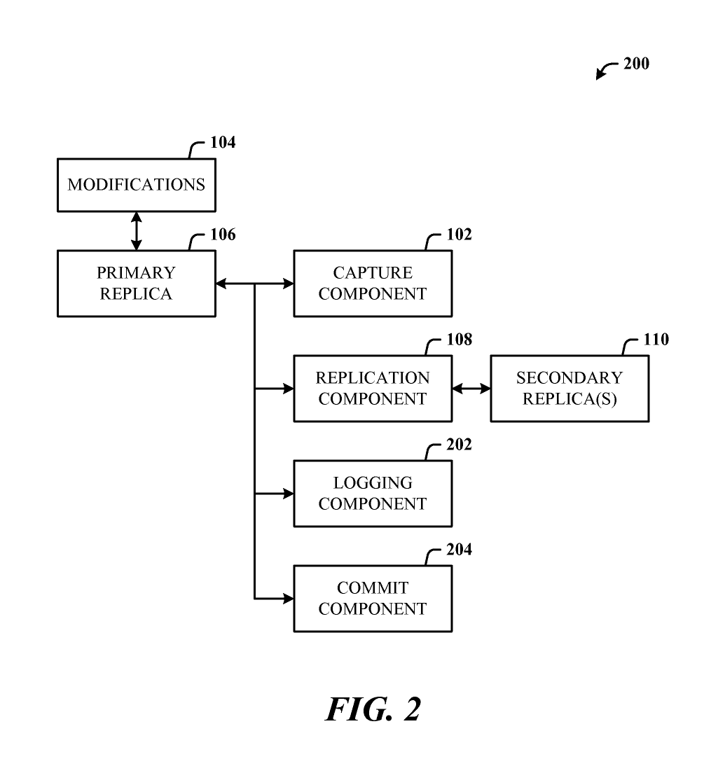

FIG. 2 illustrates an alternative embodiment of a computer-implemented database management system 200. The system 200 includes the components and entities of the system 100 of FIG. 1, as well as a logging component 202 and a commit component 204. The capture component 102 (e.g., of a distributed relational database) captures the modifications 104 performed by the primary replica 106 after the modifications 104 have been performed. The replication component 108 sends the modifications 104 to the secondary replicas 110, the secondary replicas 110 associated with the primary replica 106. The commit component 204 commits the modifications 104 (to the primary replica 106 and/or the secondary replicas 110) based on a quorum (e.g., simple majority) of the primary replica 106 and secondary replicas 110. The logging component 202 logs the modifications 104 for recovery from a failure.

Note that unlike existing database replication systems, both the schema and data are replicated. This guarantees that no schema mismatches are possible across replicas as all the changes follow the same replication protocol and always happen on the primary replica.

The changes are then asynchronously sent to multiple secondary replicas. This does not block the primary replica from making further progress until it is time for the transaction to commit. At that time, the systems waits for a quorum (e.g., half+1−half of the secondary replicas plus the single primary replica) of acknowledgements that include the secondary replicas. Waiting only for a quorum of acknowledgements allows the system to “ride-out” transient slow-downs on some of the secondary replicas and commit, even if some of the secondary replicas are failing and have not yet received a failure notification. (Failure detection can be handled outside of the replication protocol.) Note, that the maximum delta between the slowest secondary replica and the primary replica is also controlled. This guarantees manageable catch-up time during the recovery from a failure.

Note that flexible read and write quorums may be used, rather than the simple majority quorum. The read/write quorums should overlap. For example, if a total of four replicas is used and the system is configured to commit on at least two replicas, then there are three (=4−2+1) replicas available to recover from a failure.

After a quorum of secondary replicas acknowledgements, the locks held by the transaction are released and the transaction commit is acknowledged to a database system client. If a quorum of replicas fails to acknowledge, the client connection is terminated and the outcome of the transaction is undefined until the failover completes. On secondary nodes, pending transactions are tracked by <node id, transaction id> tuples and the modifications are applied as described herein.

The message format from the primary replica to the secondary replicas can include a full row, that is, all columns are sent. Sending the full row allows the transparent dealing with the online secondary case and using differential b-trees, for example, to reduce random I/O. A row format can be defined which is stable across node software versions, and can include the following: replication protocol/message version, rowset metadata version, number of columns, column ids, column lengths, column values, etc. The messages can be placed into an outgoing queue that is shared across secondary replicas that get sent and receive the messages independently.

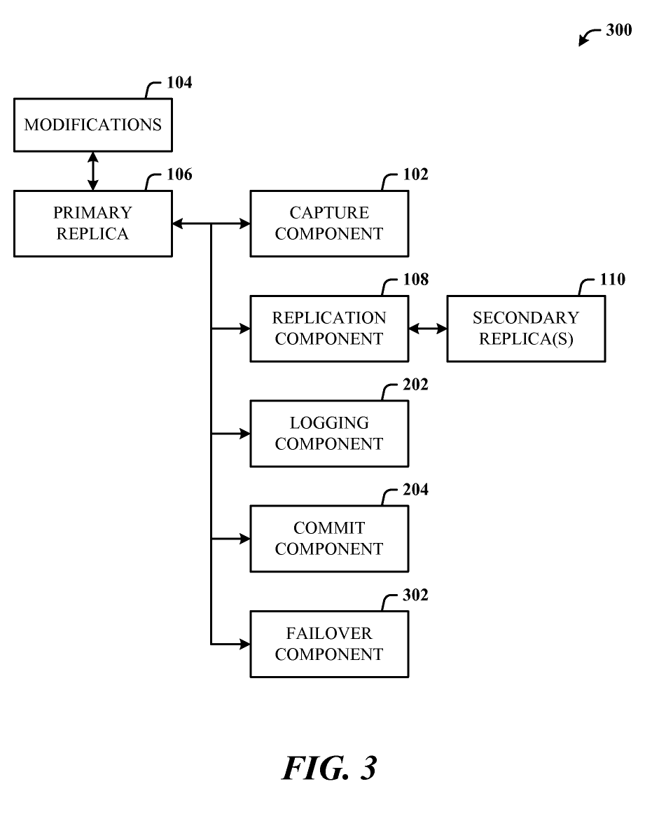

FIG. 3 illustrates an alternative embodiment of a database management system 300 having a failover system 302. The failover system 302 guarantees that the transaction will be preserved as long as a quorum of replicas is available. Note that in contrast to distributed transaction systems (also known as two-phase commit systems), this is a single-phase commit. The disclosed architecture does not employ a dedicated coordinator that needs to be redundant. Note that a difference from traditional asynchronous replication from the disclosed architecture is the ability to tolerate failovers at any point in time without data loss, whereas in asynchronous database replication systems, the amount of data loss is undefined as the primary and secondary replicas can have arbitrarily diverged from each other.

For the purposes of recovery from failure, a CSN (commit sequence number) is defined. The CSN is a tuple (e.g., epoch, number) employed to uniquely identify a committed transaction in the system. The number component is increased at the transaction commit time. The epoch is used in the CSN (which is now (epoch, number_in_epoch) to avoid incorrect new primary replica selection. Anytime a new epoch starts, number_in_epoch starts again from zero. Epoch numbers are unique (such as globally unique identifiers (GUIDs)). It is useful to have ordering for failover purposes (when a catastrophic quorum loss happens). The changes (modifications) are committed on the primary and secondary replicas using the same CSN order. The CSNs are logged in the database system transaction log and recovered during database system crash recovery. The CSNs allow the replicas to be compared during failover.

Among possible candidates for a new primary replica, the replica with the highest CSN is selected. This guarantees that all the transactions that have been acknowledged to the database system client have also been preserved as long as a quorum of replicas is available. Note that there are alternative algorithms which can be employed for choosing the new primary replica. All that is desired is to choose the CSN which was committed on a write quorum of the replicas. In practice, choosing the highest number can be a relatively simple implementation.

The epoch component of the CSN is increased each time a failover occurs. The epoch component is used to disambiguate transactions that were in-flight during failures; otherwise, duplicate transaction commit numbers can be assigned.

With respect to CSN maintenance, in order to pick a replica after failover, the system tracks how far ahead each replica has advanced. The most recent replica is selected as the primary replica and the secondary replicas are updated to the selected primary replica. The CSNs are persisted on disk for nodes to survive reboots.

A CSN can be considered a monotonically increasing number which is allocated at the transaction commit time. It is required that the CSNs are committed in the same order; otherwise, the replicas would not be comparable.

On failover, in one implementation, the current CSN can be replaced with (epoch+1, 0). To be able to detect if replicas can be caught up from each other, divergence is checked. For this purpose, a vector of CSNs is used, where the vector is represented as ((1, csn_for_epoch_{—}1), . . . , (n, csn_for_epoch_n)). This vector fully describes all the transactions the replica has ever committed. Then, two vectors can be compared with four possible outcomes: identical, A is a subset of B, B is a subset of A, and, A and B are overlapping (thus the transactions on those replicas are divergent).

Note that the CSN vectors do not depend on the actual failover policy and do not restrict declaring one node a winner versus the other node. On failover, an epoch is increased and any intermediate epochs are filled with CSN=0. In a most general implementation, A can be caught up from B if A's vector is a subset of B. However, not all the vector combinations are possible if the catch-up is assumed to be in-order. For example, for two neighboring CSN vector entries for epochs E1 and E2, A is a subset of B, that is, if ((E1, A1), (E2, A2))<((E1, B1), (E2, B2)), then A1==B1 and A1<B1, or A1<B1 and A2=0. Note that is still possible for (E3, A3)>(E3, B3) if the replica A was a primary while B was down, but B later came back. In other words, if any two non-zero CSN vector entries for epoch A match, then any entries epochs <A must also match (because if the epochs did not the catch-up would be out of order or an incompatible replica joins the replica set). Thus, to check for catch-up compatibility, only the last CSN vector entry is sent and a check is made if it is covered by the CSN vector of the primary.

In general, it can be acceptable to truncate vectors if the start part can be approximated with a very low probability of performing an incorrect comparison. One way to do this is to hash (e.g., MD5 or SHA1) the beginning parts of the vectors. Then, a replica A can be caught up from B only if the hashes match and for the numeric portions of vectors A is a subset of B.

CSN vectors truncation can be allowed after a certain number of failovers because the compatibility check will return false negatives (as the truncated part is assumed to have all zeroes).

CSNs can be allocated at the commit record logging time. Since the order of commits needs to be the same for all the replicas, the following algorithm can be utilized: acquire CSN lock on the primary, increment last CSN, add a commit record to the log manager's log cache, add an outgoing message to the message queue, unlock the CSN, wait for the local log flush, and then wait for remote commit acknowledgements.

On checkpoints, CSNs are persisted to the system tables. This allows the log to be truncated. The checkpoint runs with the following algorithm: acquire CSN lock (this stabilizes the CSN and guarantees the next logged will be no less than the checkpointed value), make a copy of the CSN vector, release CSN lock, and write the copied vector to the system table.

During a redo-pass the CSNs can be added together to form a recovered CSN vector. Rules for CSN sequence on recovery can include the following: CSNs may not have gaps in the same epoch, the first recovered CSN can be in any epoch, the second, etc., epochs start with CSN=1, and/or, gaps are allowed which correspond to epochs with zero CSNs.

After the undo-pass finishes, the persisted CSN vector is loaded from the database and the redone CSN vector added. The vector being added is greater than or equal to the persisted vector. In an alternative implementation, the recovered CSN vectors are locked and then unlocked as the undo-pass runs.

When acting as a secondary replica, the CSN sequence being sent can use the following rules: the CSNs are increasing without gaps in the same epoch, if a new epoch starts, it starts from one, and it is allowed to have epoch gaps between that last seen CSN and the new started epoch. In such case, the gap epochs are filled with zero.

After a failure, a secondary replica can attempt to catch-up from the current primary replica. Multiple mechanisms (listed from fastest to slowest) are maintained to assist: an in-memory catch-up queue, a persisted catch-up queue using database system transaction log as the durable storage, and a replica copy.

The catch-up and copy algorithms are online. The primary replica can accept both read and write requests, while a secondary replica is being caught up or copied. The catch-up algorithms identify the first transaction, which is unknown to the secondary replica (based on the CSN provided by the secondary replica during catch-up) and replay changes from there.

In certain cases catch-up may not be possible: where too many changes occurred since the failure point, and the secondary replica attempting to catch-up has diverged from the current primary replica by committing a transaction that no other replica has committed. The replication system attempts to minimize this occurrence by committing changes based on the quorum (of the secondary replicas) before committing on the primary replica. The divergence is detected by comparing a vector of CSNs for the last N epochs.

In these cases, the copy algorithm is used to catch-up the secondary replica. The copy algorithm has the following properties. The copy algorithm is online. This is accomplished by having the copy run in two data streams: a copy scan stream and an online change stream. The two streams are synchronized using locks at the primary replica. The copy scan stream uses shared locks (or schema stability locks) versus the online change stream which uses exclusive (or schema modification) locks. This guarantees that no reordering is possible across the two data streams.

The copy operation is safe, since it does not destroy the transactional consistency of the secondary partition until the copy completes successfully. This is accomplished by isolating the current set of schema objects and rows from the target of the copy operation. The copy operation does not have a catch-up phase and is guaranteed to complete as soon as the copy scan finishes.

During both catch-up and copy, the secondary replica operates in an “idempotent mode”, which is defined as: inserting a row (or create schema entity) if the row is not there, updating a row (or modifying schema entity) if the row is there, and deleting a row (or drop schema entity) if the row is there.

The idempotent mode is employed because: during catch-up, it is possible to have overlapping transactions that have already committed on the secondary (idempotent mode allows ignoring the already applied changes at the secondary replica), and during copy, it is possible for the copy stream to send rows or schema entities that were just created as part online stream. It is also possible for the online stream to attempt to update or delete rows that have not been copied yet.

With respect to secondary replicas, secondary replica implementation can be parallel to achieve higher use of computer system resources. To be able to parallelize database transactions while maintaining correct results certain operations are designated as barriers. All the subsequent operations as received from the primary replica wait for barrier operations to complete before proceeding.

The following operations are considered barriers: commits (to maintain correct commit sequence) and rollbacks (to release locks). Other barriers optionally employed can include index state modifications, partition shutdown, and an explicit barrier. All the row and schema operations wait for barriers that were generated by the primary replica before the associated order to complete before proceeding. This guarantees that all the modifications to rows are carried out in the correct order.

Anything following a commit needs to wait for the commit to complete because modifications to the rows may rely on the previous results (such as delete of a previously inserted row). Note the barrier may be released as soon as the CSN is added to the log cache. This allows for group commits.

Rollbacks (e.g., rollback nested, rollback to a savepoint) generally do not have to be strict barriers because the normal SQL server locks will prevent concurrent modifications to the resources. However, it would be possible to reorder a modification which gets rolled back with a subsequent commit which, for example, inserts the same row the previous transaction tried to insert (and rolled back), thus, getting a duplicate key violation. Thus, the rollbacks are also barriers. Note that the barrier is not released as soon as the rollback starts. The rollbacks can signal completion as soon rollback starts.

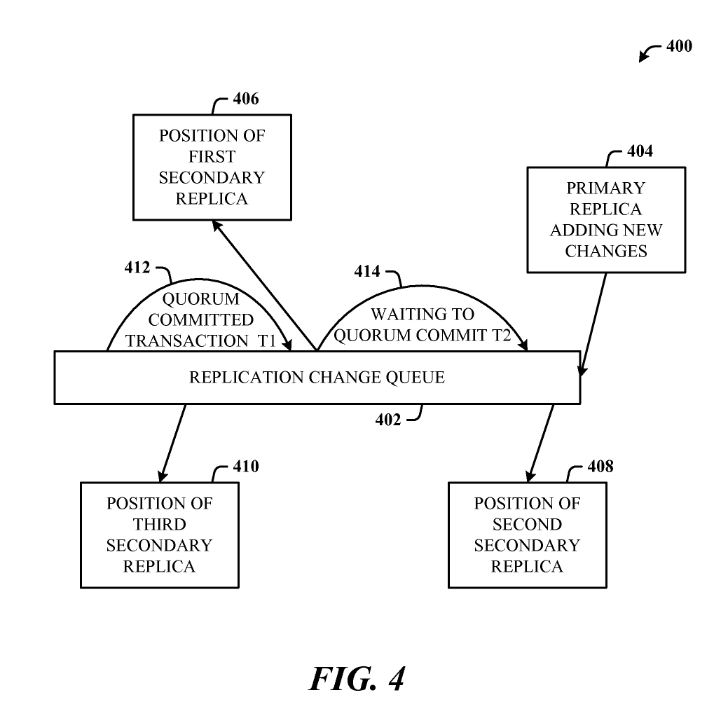

FIG. 4 illustrates a diagram 400 that represents transaction commits relative to a replication queue 402. The diagram 400 shows a primary replica 404 and three secondary replicas: a first secondary replica 406, a second secondary replica 408, and a third secondary replica 410. The primary replica 404 adds changes to the replication change queue 402 for processing to the secondary replicas (406, 408, and 410). At a defined time period 412, a quorum of the replicas (primary and secondaries) has been reached and the transaction T1 is committed (e.g., to the third secondary replica 410. After time period 412, the queue 402 sends one or more changes to the first secondary replica 406 as a second transaction T2. At a time period 414, the system waits for a quorum to be received once the changes to at least the first secondary replica 406, and other replicas, are committed. After the time period 414, another change is sent to the second secondary replica 408, and the process continues.

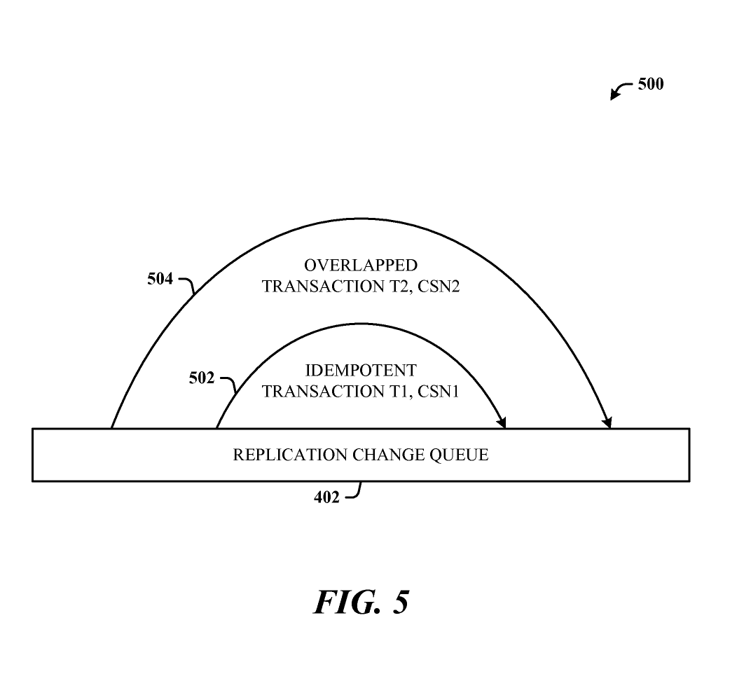

FIG. 5 illustrates a diagram 500 of catch-up and transaction overlap processing according to the disclosed database management architecture. Consider that a first transaction T1 is an idempotent transaction and has an associated CSN1, the transaction T1 operating over a time period 502 on the replication change queue 402. It is possible that an overlapped transaction, a second transaction T2 and an associated CSN2, can operate over a greater time period 504 on the replication change queue 402.

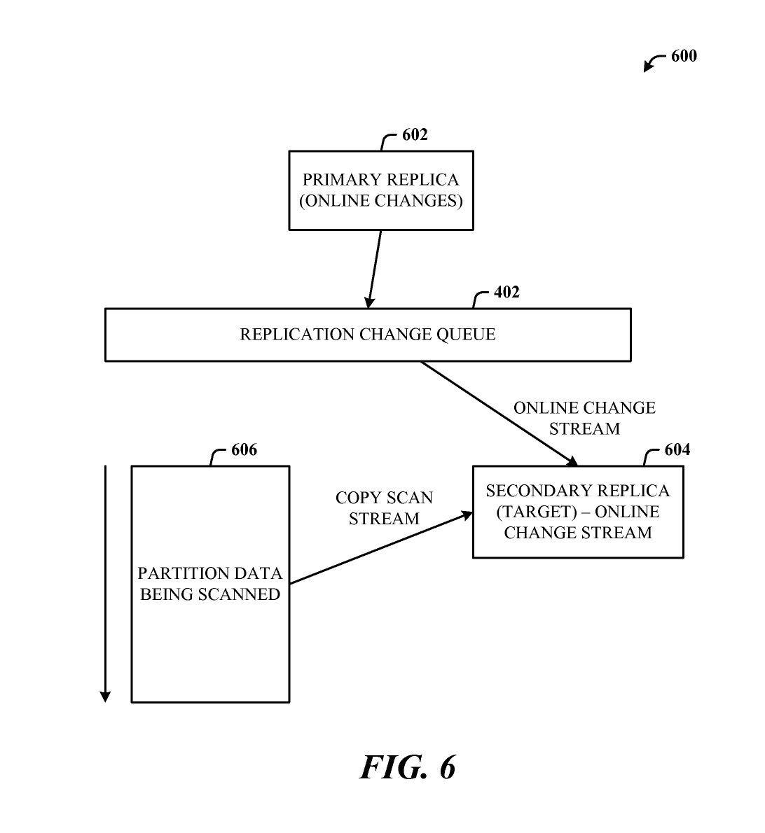

FIG. 6 illustrates a diagram 600 for a copy algorithm for online copies. A primary replica 602 passes online changes to the change queue 402. The copy algorithm can be used to catch-up a secondary replica 604. The copy algorithm is online, and is accomplished by having the copy run in two data streams: the copy scan stream and the online change stream. The copy scan stream is used on partition data 606 being scanned to the secondary replica 604, and the online change stream is used with the change queue 402 to the secondary replica 604. The two streams are synchronized using locks at the primary replica 602. The copy scan stream uses shared locks (or schema stability locks) versus the online change stream, which uses exclusive (or schema modification) locks. This guarantees that no reordering is possible across the two data streams.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

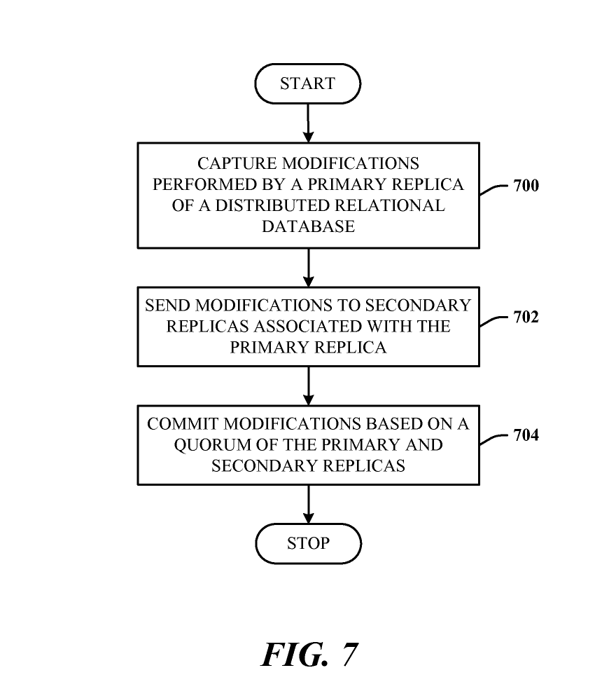

FIG. 7 illustrates a computer-implemented method of database management employing a processor and memory, in accordance with the disclosed architecture. At 700, modifications performed by a primary replica of a distributed relational database are captured. At 702, the modifications are sent to secondary replicas associated with the primary replica. At 704, the modifications are committed based on a quorum of the primary and secondary replicas.

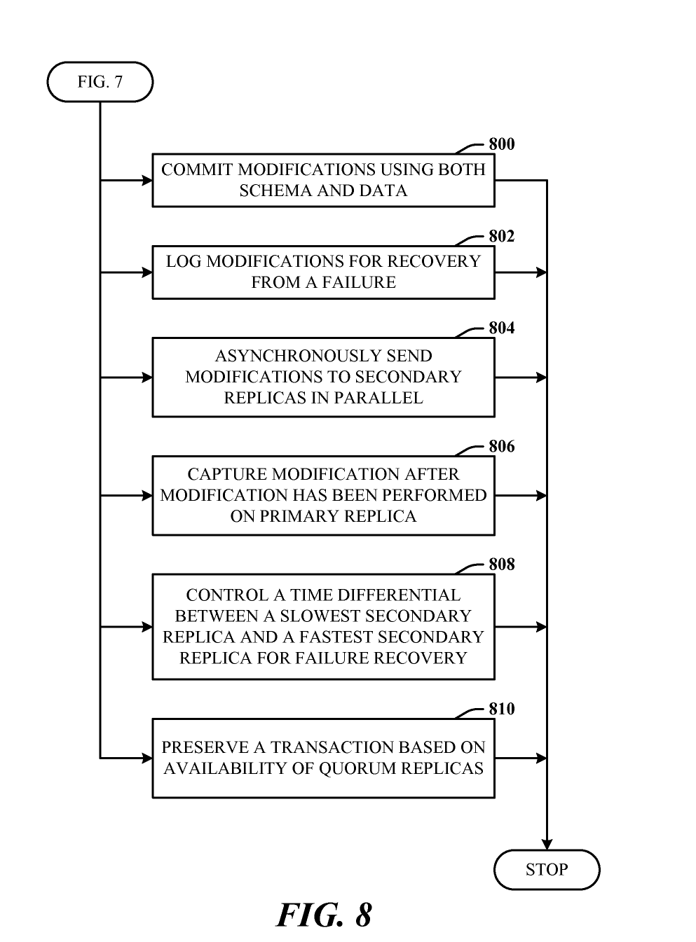

FIG. 8 illustrates further aspects of the method of FIG. 7. At 800, the modifications are committed using both schema and data. At 802, the modifications are logged for recovery from a failure. At 804, the modifications are sent asynchronously to the secondary replicas in parallel. At 806, a modification is captured after the modification has been performed on the primary replica. At 808, a time differential between a slowest secondary replica and a fastest secondary replica for failure recovery is controlled. At 810, a transaction is preserved based on availability of the quorum the replicas.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

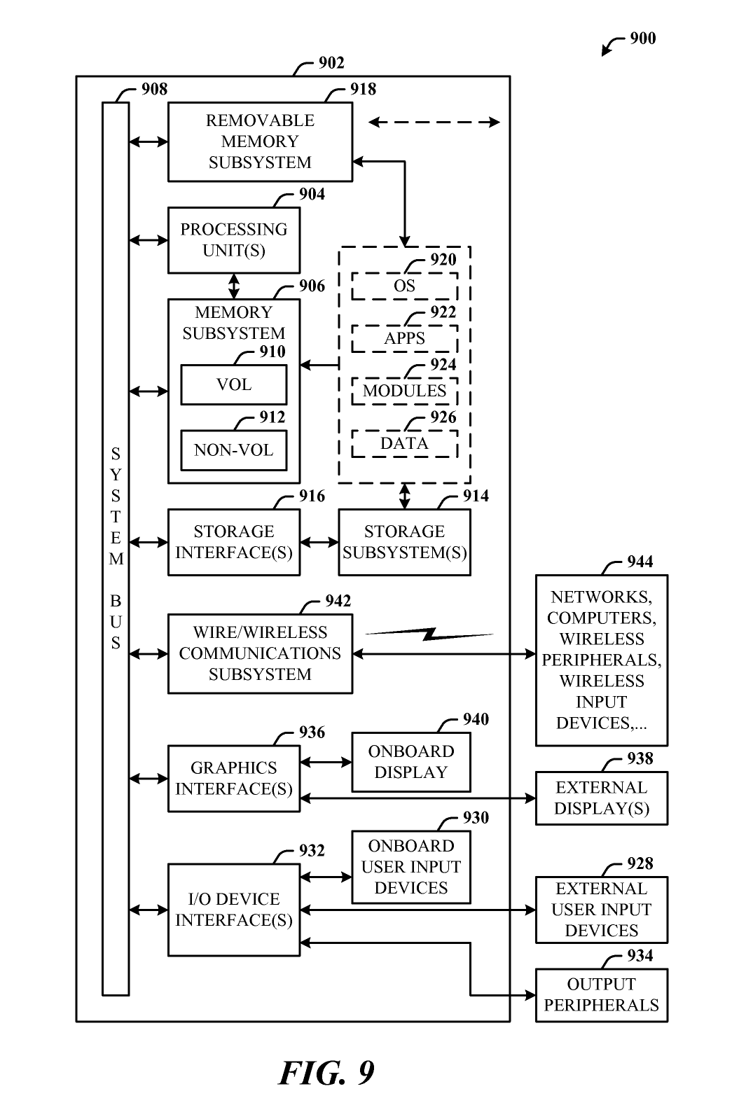

Referring now to FIG. 9, there is illustrated a block diagram of a computing system 900 that executes database management in accordance with the disclosed architecture. In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904, a computer-readable storage such as a system memory 906, and a system bus 908. The processing unit(s) 904 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 906 can include computer-readable storage such as a volatile (VOL) memory 910 (e.g., random access memory (RAM)) and non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components. The storage subsystem(s) 914 can include one or more of a hard disk drive (HDD), a magnetic floppy disk drive (FDD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The one or more application programs 922, other program modules 924, and program data 926 can include the entities and components of the system 100 of FIG. 1, the entities and components of the system 200 of FIG. 2, the entities and components of the system 300 of FIG. 3, the actions represented in the diagram 400 of FIG. 4, the actions represented in the diagram 500 of FIG. 5, the actions represented in the diagram 600 of FIG. 6, and the methods represented by the flow charts of FIGS. 7-8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so forth. Computer readable media can be any available media that can be accessed by the computer 902 and includes volatile and non-volatile internal and/or external media that is removable or non-removable. For the computer 902, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 902, programs, and data using external user input devices 928 such as a keyboard and a mouse. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example. These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated and described aspects can be practiced in distributed computing environments where certain tasks are performed by remote processing devices that are linked through a communications network. In a distributed computing environment, program modules can be located in local and/or remote storage and/or memory system.

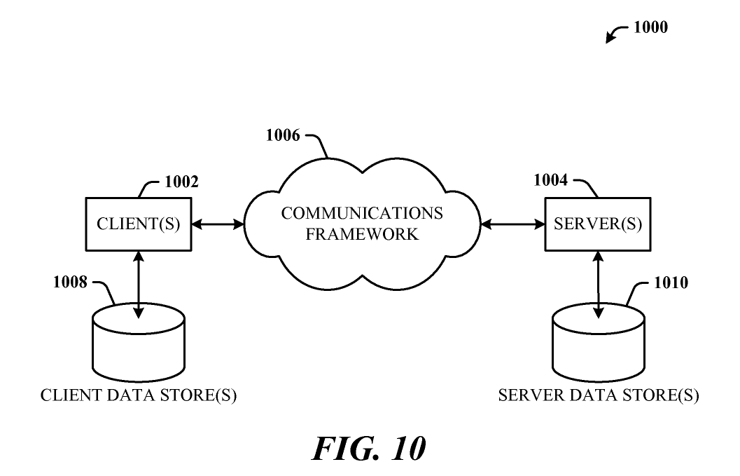

Referring now to FIG. 10, there is illustrated a schematic block diagram of a computing environment 1000 that utilizes data management according to disclosed embodiments. The environment 1000 includes one or more client(s) 1002. The client(s) 1002 can be hardware and/or software (e.g., threads, processes, computing devices). The client(s) 1002 can house cookie(s) and/or associated contextual information, for example.

The environment 1000 also includes one or more server(s) 1004. The server(s) 1004 can also be hardware and/or software (e.g., threads, processes, computing devices). The servers 1004 can house threads to perform transformations by employing the architecture, for example. One possible communication between a client 1002 and a server 1004 can be in the form of a data packet adapted to be transmitted between two or more computer processes. The data packet may include a cookie and/or associated contextual information, for example. The environment 1000 includes a communication framework 1006 (e.g., a global communication network such as the Internet) that can be employed to facilitate communications between the client(s) 1002 and the server(s) 1004.

Communications can be facilitated via a wire (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented database management system having a physical media, comprising:
a capture component of a distributed relational database for capturing modifications performed by a primary replica; and
a replication component for sending the modifications to secondary replicas associated with the primary replica.

2. The system of claim 1, wherein the capture component captures the modifications by the primary replica after the modifications have been performed.

3. The system of claim 1, wherein the modifications are committed based on a quorum of the primary and secondary replicas.

4. The system of claim 1, wherein the secondary replicas catch-up to state of the primary replica.

5. The system of claim 1, wherein the replication component sends the modifications to the secondary replicas in parallel.

6. The system of claim 1, wherein the replication component performs online copy of schema and data from the primary replica to a secondary replica.

7. The system of claim 1, further comprising a logging component for logging the modifications for recovery from a failure.

8. The system of claim 1, further comprising an identifier that uniquely identifies a committed transaction, the modifications committed on the primary replica and secondary replicas using a same identifier order.

9. A computer-implemented database management system having a physical media, comprising:
a capture component of a distributed relational database for capturing modifications performed by a primary replica after the modifications have been performed;
a replication component for sending the modifications to secondary replicas associated with the primary replica; and
a commit component for committing the modifications based on a quorum of the primary and secondary replicas.

10. The system of claim 9, wherein the secondary replicas catch-up to state of the primary replica.

11. The system of claim 9, wherein the replication component sends the modifications to the secondary replicas in parallel.

12. The system of claim 9, wherein the replication component performs online copy of schema and data from the primary replica to a secondary replica.

13. The system of claim 9, further comprising identifiers for each modification that uniquely identify a committed modification, the modifications committed on the primary replica and secondary replicas using a same identifier order.

14. A computer-implemented method of database management employing a processor and memory, comprising:
capturing modifications performed by a primary replica of a distributed relational database;
sending the modifications to secondary replicas associated with the primary replica; and
committing the modifications based on a quorum of the primary and secondary replicas.

15. The method of claim 14, further comprising committing the modifications using both schema and data.

16. The method of claim 14, further comprising logging the modifications for recovery from a failure.

17. The method of claim 14, further comprising asynchronously sending the modifications to the secondary replicas in parallel.

18. The method of claim 14, further comprising capturing a modification after the modification has been performed on the primary replica.

19. The method of claim 14, further comprising controlling a time differential between a slowest secondary replica and a fastest secondary replica for failure recovery.

20. The method of claim 14, further comprising preserving a transaction based on availability of the quorum the replicas.
